(19) United States
(12) Patent Application Publication
(10) Pub. No.: US 2016/0238042 A1
(43) Pub. Date: Aug. 18, 2016

(54) Driving Device Using Pneumatic-Hydraulic Pressure as a Power Source for a Vehicle

(71) Applicant: Eurocharm Holding Co., Ltd., Grand Cayman (KY)

(72) Inventor: Shang-Shung Jen, Taipei City (TW)

(21) Appl. No.: 14/623,594

(22) Filed: Feb. 17, 2015

(51) Int. Cl. F15B 11/072; F15B 1/02

(52) U.S. Cl. CPC F15B 11/0725; F15B 1/024; F15B 2211/216

(57) ABSTRACT

A driving device using pneumatic-hydraulic pressure as a power source for a vehicle has a pneumatic cylinder filled with high pressure air, a hydraulic cylinder filled with high pressure air and high pressure hydraulic fluid, a first supplementary cylinder, and a secondary supplementary cylinder. The hydraulic cylinder is connected with the pneumatic cylinder and is connected to the first supplementary cylinder and the secondary supplementary cylinder via a hydraulic motor. The first supplementary cylinder and the second supplementary cylinder are alternately pressurized, so as to alternately supply the pressurized hydraulic fluid to the hydraulic cylinder. Thus, the hydraulic cylinder can provide the pressurized hydraulic fluid with a pre-determined pressure to constantly drive the hydraulic motor. The driving device meets requirements of environmental protection from zero waste discharge.

### BACKGROUND OF THE INVENTION

1. Field of the Invention

The present invention relates to a driving device for a vehicle, and more particularly, the driving device pressurizes hydraulic fluid with high pressure air, thus forms a pneumatic-hydraulic pressure as a power source to drive the vehicle.

2. Description of the Prior Art(s)

A conventional vehicle, such as a sedan or an automobile, may be driven by a combustion engine that is powered by burning gasoline or diesel fuel, by an electric motor that is powered by electricity, or by pneumatic motor that is powered by high pressure air. By driving wheels of the conventional vehicle to rotate, the conventional vehicle can move forward.

However, since the combustion engine is powered by burning gasoline or diesel fuel, a large amount of exhaust gas, especially carbon monoxide (CO), is exhausted, which causes environmental problems. As for the electric motor, batteries for storing electricity have to be replaced regularly, and the discarded batteries also cause environmental problems. In addition, since charging a vehicle battery takes a long time, the vehicle battery cannot be provided for powering the electric motor to drive the conventional vehicle in time. Moreover, torque of the pneumatic motor that is powered by the high pressure air to drive the Wheels of the conventional vehicle to rotate is hard to be boosted. Therefore, applicability of the pneumatic motor is restricted.

To overcome the shortcomings, the present invention provides a driving device using pneumatic-hydraulic pressure as a power source for a vehicle to mitigate or obviate the aforementioned problems.

### SUMMARY OF THE INVENTION

The main objective of the present invention is to provide a driving device using pneumatic-hydraulic pressure as a power source for a vehicle. The driving device has a pneumatic cylinder filled with high pressure air, a hydraulic cylinder filled with high pressure air and high pressure hydraulic fluid, a first supplementary cylinder, and a secondary supplementary cylinder. The hydraulic cylinder is connected with the pneumatic cylinder and is connected to the first supplementary cylinder and the secondary supplementary cylinder via a hydraulic motor.

The first supplementary cylinder and the second supplementary cylinder are alternately pressurized, so as to alternately supply the pressurized hydraulic fluid to the hydraulic cylinder. Thus, the hydraulic cylinder can provide the pressurized hydraulic fluid with a pre-determined pressure to constantly drive the hydraulic motor. The driving device meets requirements of environmental protection from zero waste discharge.

Other objectives, advantages and novel features of the invention will become more apparent from the following detailed description when taken in conjunction with the accompanying drawings.

### BRIEF DESCRIPTION OF THE DRAWINGS

FIG. 1 is a first operational schematic diagram of a driving device using pneumatic-hydraulic pressure as a power source for a vehicle in accordance with the present invention;

FIG. 2 is a second operational schematic diagram of the driving device shown in FIG. 1;

FIG. 3 is a third operational schematic diagram of the driving device shown in FIG. 1; and

FIG. 4 is a fourth operational schematic diagram of the driving device shown in FIG. 1.

### DETAILED DESCRIPTION OF THE PREFERRED EMBODIMENTS

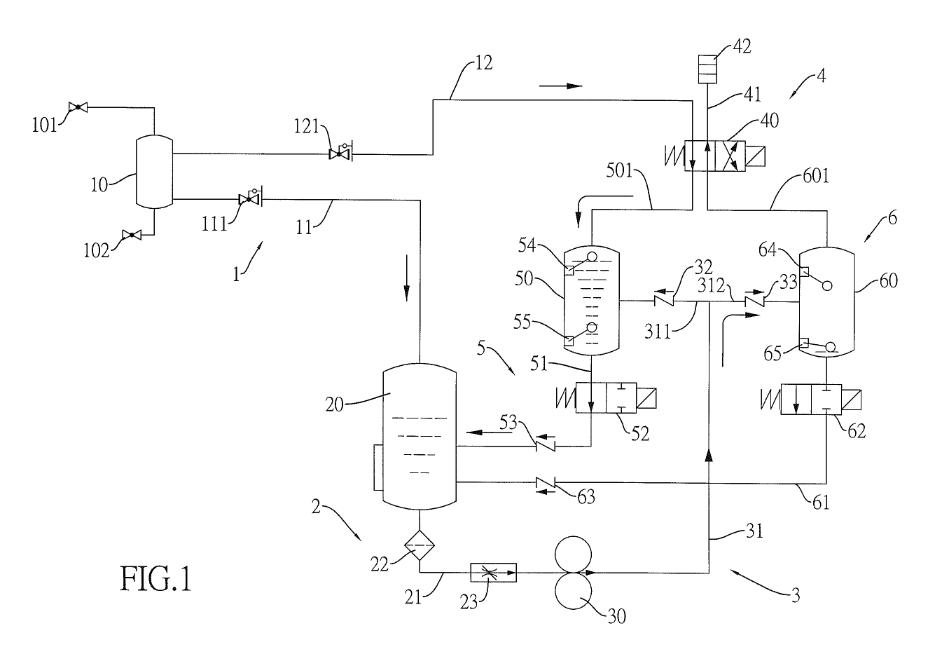

With reference to FIG. 1, a driving device using pneumatic-hydraulic pressure as a power source for a vehicle in accordance with the present invention comprises a high pressure pneumatic cylinder set 1, a hydraulic cylinder set 2, a hydraulic motor set 3, a solenoid valve set 4, a first supplementary cylinder set 5, and a second supplementary cylinder set 6.

The high pressure pneumatic cylinder set 1 includes a pneumatic cylinder 10, a pneumatic drive pipe 11, a drive pressure regulator 111, a re-charge pipe 12, and a re-charge pressure regulator 121.

The pneumatic cylinder 10 is a hollow tube and has a filling inlet 101 and a drainage outlet 102. The pneumatic cylinder 10 is connected with a high pressure air generator (not shown) through the filling inlet 101, such that the high pressure air generator fills pressurized air into the pneumatic cylinder 10 via the filling inlet 101.

The pneumatic drive pipe 11 has two ends. One of the ends of the pneumatic drive pipe 11 is connected to the pneumatic cylinder 10 and the other end of the pneumatic drive pipe 11 is connected to a hydraulic cylinder 20 of the hydraulic cylinder set 2. The drive pressure regulator 111 is mounted on the pneumatic drive pipe 11. The drive pressure regulator 111 reduces air pressure of the pressurized pressure air from the pneumatic cylinder 10 to a drive air pressure. The re-charge pipe 12 has two ends. One of the ends of the re-charge pipe 12 is connected to the pneumatic cylinder 10 and the other end of the re-charge pipe 12 is connected to a main solenoid valve 40 of the solenoid valve set 4. The re-charge pressure regulator 121 is mounted on the re-charge pipe 12. The re-charge pressure regulator 121 reduces the air pressure of the pressurized pressure air from the pneumatic cylinder 10 to a re-charge air pressure. The drive air pressure in the pneumatic drive pipe 11 is lower than the re-charge air pressure in the re-charge pipe 12. For instance, the air pressure in the pneumatic cylinder 10 may be about 300 bar, the drive air pressure in the pneumatic drive pipe 11 may be about 10 bar, and the re-charge air pressure in the re-charge pipe 12 may be about 20 bar.

The hydraulic cylinder set 2 includes said hydraulic cylinder 20, a hydraulic drive pipe 21, a throttle valve 23, and a filter 22. The hydraulic cylinder 20 is a hollow tube, is disposed vertically, and is filled with air and hydraulic fluid. The air fills an upper portion of the hydraulic cylinder 20. The hydraulic fluid fills a lower portion of the hydraulic cylinder 20. The hydraulic cylinder 20 has a bottom and a top. The top of the hydraulic cylinder 20 is connected with the pneumatic drive pipe 11. The hydraulic drive pipe 21 has two ends. One of the ends of the hydraulic drive pipe 21 is connected to the bottom of the hydraulic cylinder 20, and the other end of the hydraulic drive pipe 21 is connected to a hydraulic motor 30 of the hydraulic motor set 3. The throttle valve 23 is mounted on the hydraulic drive pipe 21. The filter 22 is mounted on the hydraulic drive pipe 21 and upstream of the throttle valve 23. Specifically, the filter 22 is mounted between the bottom of the hydraulic cylinder 20 and the throttle valve 23. The filter 22 filters the hydraulic fluid that flows in the hydraulic drive pipe 21 and from the hydraulic cylinder 20. The hydraulic motor set 3 includes said hydraulic motor 30, a discharge pipe 31, a first branch pipe 311, a second branch pipe 312, a first non-return valve 32, and a second non-return valve 33.

The hydraulic motor 30 is connected to a driving shaft of the vehicle and has an output port and an input port. The input port of the hydraulic motor 30 is connected to the hydraulic drive pipe 21. Thus, the hydraulic motor 30 can be driven by the hydraulic fluid from the hydraulic cylinder set 2 and then drives the driving shaft of the vehicle to rotate. The throttle valve 23 regulates an amount of the hydraulic fluid entering the hydraulic motor 30, so as to control a rotational speed of the driving shaft. Thus, speed of the vehicle is controlled accordingly.

The discharge pipe 31 has two ends. One of the ends of the discharge pipe 31 is connected to the output port of the hydraulic motor 30 and the other end of the discharge pipe 31 is connected to the first branch pipe 311 and the second branch pipe 312. The first non-return valve 32 is mounted on the first branch pipe 311. The second non-return valve 33 is mounted on the second branch pipe 312.

The solenoid valve set 4 includes a bleed pipe 41 and the main solenoid valve 40. The bleed pipe 41 has two ends. The main solenoid valve 40 may be a four-way two-position solenoid valve and has two upper side connections and two lower side connections. The upper side connections of the main solenoid valve 40 are respectively connected to the re-charge pipe 12 and one of the ends of the bleed pipe 41. The other end of the bleed pipe 41 is connected with a muffler 42. The lower side connections of the main solenoid valve 40 are respectively connected to a first supplementary cylinder 50 via a first guiding pipe 501 and a second supplementary cylinder 60 via a second guiding pipe 601.

The first supplementary cylinder set 5 includes said first supplementary cylinder 50, said first guiding pipe 501, a first supplementary pipe 51, a first solenoid valve 52, a non-return valve 53, a high level switch 54, and a low level switch 55.

The first supplementary cylinder 50 is a hollow tube and is disposed vertically. The first supplementary cylinder 50 is filled with air and hydraulic fluid and is connected to the first branch pipe 311. The first non-return valve 32 that is installed on the first branch pipe 311 only allows the hydraulic fluid that is filled in the first branch pipe 311 to flow toward the first supplementary cylinder 50. The first supplementary cylinder 50 has a top and a bottom. The first guiding pipe 501 has two ends respectively connected to the top of the first supplementary cylinder 50 and the main solenoid valve 40.

The first supplementary pipe 51 has two ends respectively connected to the bottom of the first supplementary cylinder 50 and the hydraulic cylinder 20. The first solenoid valve 52 is mounted on the first supplementary pipe 51. In the preferred embodiment, the first solenoid valve 52 is a two-way two-position solenoid valve. The non-return valve 53 of the first supplementary cylinder set 5 is mounted on the first supplementary pipe 51 and in between the first solenoid valve 52 and the hydraulic cylinder 20. The non-return valve 53 of the first supplementary cylinder set 5 only allows the hydraulic fluid in the first supplementary pipe 51 to flow toward the hydraulic cylinder 20.

The high level switch 54 of the first supplementary cylinder set 5 is mounted in the first supplementary cylinder 50 and is electrically connected to the main solenoid valve 40. The low level switch 55 of the first supplementary cylinder set 5 is mounted in the first supplementary cylinder 50 and below the high level switch 54 of the first supplementary cylinder set 5, and is electrically connected to the first solenoid valve 52. When the hydraulic fluid in the first supplementary cylinder 50 is dropped to a low level position, the low level switch 55 of the first supplementary cylinder set 5 is switched to block the first supplementary pipe 51.

The second supplementary cylinder set 6 includes said second supplementary cylinder 60, said second guiding pipe 601, a second supplementary pipe 61, a second solenoid valve 62, a non-return valve 63, a high level switch 64, and a low level switch 65.

The second supplementary cylinder 60 is a hollow tube and is disposed vertically. The second supplementary cylinder 60 is filled with air and hydraulic fluid and is connected to the second branch pipe 312. The second non-return valve 33 that is installed on the second branch pipe 311 only allows the hydraulic fluid that is filled in the second branch pipe 312 to flow toward the second supplementary cylinder 60. The second supplementary cylinder 60 has a top and a bottom. The second guiding pipe 601 has two ends respectively connected to the top of the second supplementary cylinder 60 and the main solenoid valve 40.

The second supplementary pipe 61 has two ends respectively connected to the bottom of the second supplementary cylinder 60 and the hydraulic cylinder 20. The second solenoid valve 62 is mounted on the second supplementary pipe 61. In the preferred embodiment, the second solenoid valve 62 is a two-way two-position solenoid valve. The non-return valve 63 of the second supplementary cylinder set 6 is mounted on the second supplementary pipe 61 and in between the second solenoid valve 62 and the hydraulic cylinder 20. The non-return valve 63 of the second supplementary cylinder set 6 only allows the hydraulic fluid in the second supplementary pipe 61 to flow toward the hydraulic cylinder 20.

The high level switch 64 of the second supplementary cylinder set 6 is mounted in the second supplementary cylinder 60 and is electrically connected to the main solenoid valve 40. The low level switch 65 of the second supplementary cylinder set 6 is mounted in the second supplementary cylinder 60 and below the high level switch 64 of the second supplementary cylinder set 6, and is electrically connected to the second solenoid valve 62. When the hydraulic fluid in the second supplementary cylinder 60 is dropped to a low level position, the low level switch 65 of the second supplementary cylinder set 6 is switched to block the second supplementary pipe 61.

As shown in FIG. 1, during operation, the pressurized air in the pneumatic cylinder 10 flows through the drive pressure regulator 111 and the pneumatic drive pipe 11 to the hydraulic cylinder 20, such that the hydraulic fluid in the hydraulic cylinder 20 has the same pressure as the drive air pressure in the pneumatic drive pipe 11. The pressurized air in the pneumatic cylinder 10 flows through the re-charge pressure regulator 121, the re-charge pipe 12, and the main solenoid valve 40 to the first supplementary cylinder 50. Since the re-charge air pressure in the re-charge pipe 12 is higher than the drive air pressure in the pneumatic drive pipe 11, the hydraulic fluid in the first supplementary cylinder 50 is forced to flow through the first supplementary pipe 51, the first solenoid valve 52, and the non-return valve 53 of the first supplementary cylinder set 5 into the hydraulic cylinder 20.

The hydraulic fluid in the hydraulic cylinder 20 further flows through the hydraulic drive pipe 21 and is regulated by the throttle valve 23 so as to drive the hydraulic motor 30 and drive the driving shaft of the vehicle to rotate. Since fluid pressure of the hydraulic fluid in the discharge pipe 31 is lower than the air pressure in the first supplementary cylinder 50, the hydraulic fluid in the discharge pipe 31 flows toward the second supplementary cylinder 60.

Thus, the hydraulic fluid with low pressure in the discharge pipe 31 flows through the second branch pipe 312 and the second non-return valve 33 to the second supplementary cylinder 60. For the time being, the hydraulic fluid in the second supplementary cylinder 60 is at the low level position and the low level switch 65 of the second supplementary cylinder set 6 is switched to block the second supplementary pipe 61. The main solenoid valve 40 is switched to allow the second guiding pipe 601 to connect with the bleed pipe 41. Accordingly, with the hydraulic fluid flowing into the second supplementary cylinder 60 via the second branch pipe 312, the air in the second supplementary cylinder 60 is exhausted through the second guiding pipe 601, the bleed pipe 41, and the muffler 42.

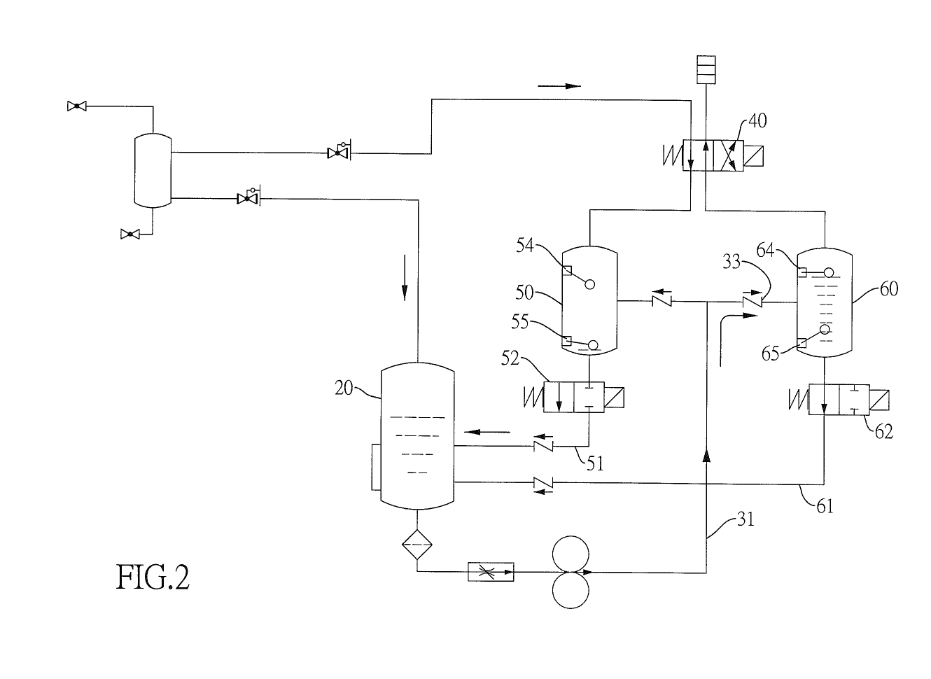

With further reference to FIG. 2, as the hydraulic fluid from the discharge pipe 31 keeps flowing into the second supplementary cylinder 60, the hydraulic fluid in the second supplementary cylinder 60 increases and the hydraulic fluid in the first supplementary cylinder 50 decreases. When the hydraulic fluid in the first supplementary cylinder 50 is decreased to the low level position and switches the low level switch 55 of the first supplementary cylinder set 5, the first solenoid valve 52 is switched off to stop supplying the hydraulic fluid to the hydraulic cylinder 20. Meanwhile, the hydraulic fluid in the second supplementary cylinder 60 is increased to become higher than the low level position, and the second solenoid valve 62 is switched on to allow the hydraulic fluid in the second supplementary cylinder 60 to flow into the second supplementary pipe 61.

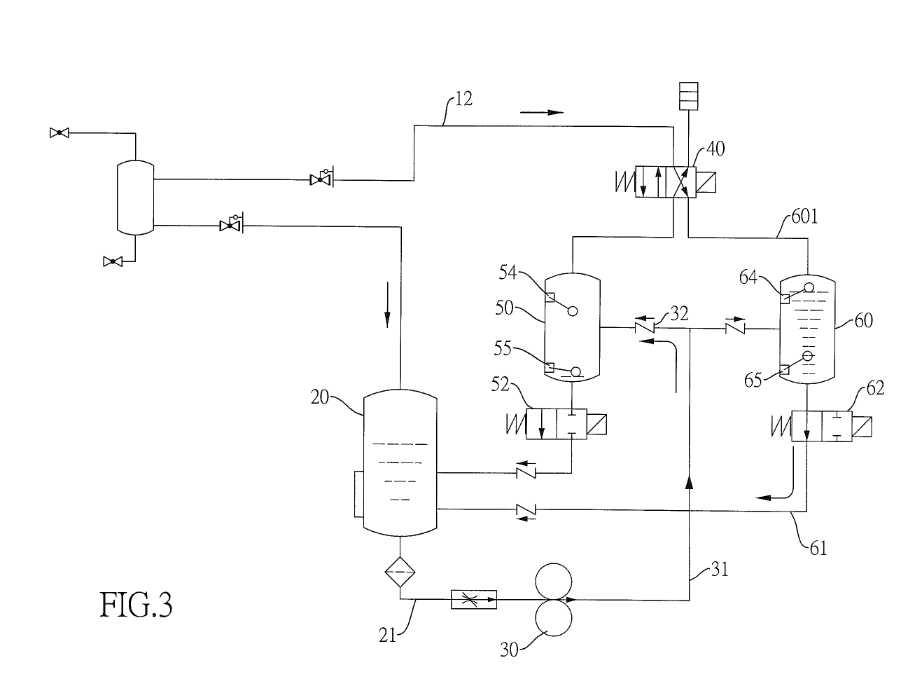

With further reference to FIG. 3, as the hydraulic fluid in the second supplementary cylinder 60 is increased to a high level position to activate the high level switch 64 of the second supplementary cylinder set 6, the main solenoid valve 40 is switched to allow the re-charge pipe 12 to connect with the second guiding pipe 601, and the second solenoid valve 62 is switched to allow the second supplementary cylinder 60 to connect with the second supplementary pipe 61. Thus, the hydraulic fluid in the second supplementary cylinder 60 flows into the hydraulic cylinder 20, and the hydraulic fluid in the hydraulic cylinder 20 flows through the hydraulic drive pipe 21 to drive the hydraulic motor 30 and drive the driving shaft of the vehicle to rotate. Then the hydraulic fluid in the discharge pipe 31 flows to the first supplementary cylinder 50 via the discharge pipe 31 and the first non-return valve 32.

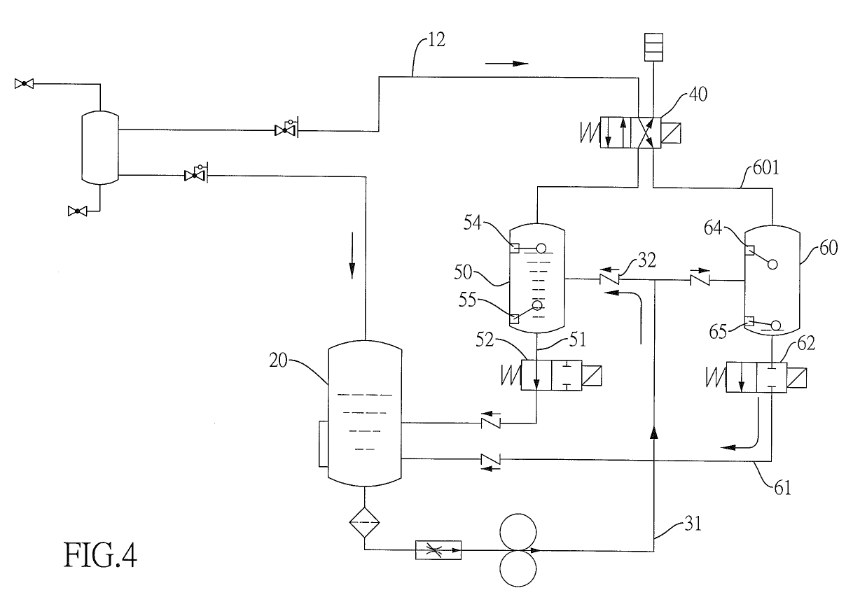

With further reference to FIG. 4, as the hydraulic fluid from the discharge pipe 31 keeps flowing into the first supplementary cylinder 50, the hydraulic fluid in the first supplementary cylinder 50 increases and the hydraulic fluid in the second supplementary cylinder 60 decreases. When the hydraulic fluid in the second supplementary cylinder 60 is decreased to the low level position and switches the low level switch 65 of the second supplementary cylinder set 6, the second solenoid valve 62 is switched off to stop supplying the hydraulic fluid to the hydraulic cylinder 20. Meanwhile, the hydraulic fluid in the first supplementary cylinder 50 is increased to become higher than the low level position, and the first solenoid valve 52 is switched on to allow the hydraulic fluid in the first supplementary cylinder 50 to flow into the first supplementary pipe 51. As shown in FIG. 1, as the hydraulic fluid in the first supplementary cylinder 50 is increased to a high level position to activate the high level switch 54 of the first supplementary cylinder set 5, the main solenoid valve 40 is switched to allow the re-charge pipe 12 to connect with the first guiding pipe 501 and the second guiding pipe 601 to connect with the bleed pipe 41.

The first supplementary cylinder 50 and the second supplementary cylinder 60 are alternately pressurized by the re-charge air pressure from the re-charge pipe 12 and alternately supply the hydraulic fluid to the hydraulic cylinder 20, such that the hydraulic cylinder 20 can provide the hydraulic fluid with a pre-determined high pressure to constantly drive the hydraulic motor 30.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A driving device using pneumatic-hydraulic pressure as a power source for a vehicle comprising:
a high pressure pneumatic cylinder set including
a pneumatic cylinder being a hollow tube and having a filling inlet;
a pneumatic drive pipe having two ends, one of the ends of the pneumatic drive pipe connected to the pneumatic cylinder;
a drive pressure regulator mounted on the pneumatic drive pipe and reducing air pressure of pressurized pressure air from the pneumatic cylinder to a drive air pressure;
a re-charge pipe having two ends, one of the ends of the re-charge pipe connected to the pneumatic cylinder; and
a re-charge pressure regulator mounted on the re-charge pipe and reducing the air pressure of the pressurized pressure air from the pneumatic cylinder to a re-charge air pressure;
wherein the drive air pressure in the pneumatic drive pipe is lower than the re-charge air pressure in the re-charge pipe;
a hydraulic cylinder set including
a hydraulic cylinder being a hollow tube and filled with air and hydraulic fluid, the hydraulic cylinder having a bottom and a top, the top of the hydraulic cylinder connected with the other end of the pneumatic drive pipe;
a hydraulic drive pipe having two ends, one of the ends of the hydraulic drive pipe connected to the bottom of the hydraulic cylinder; and
a throttle valve mounted on the hydraulic drive pipe;
a hydraulic motor set including
a hydraulic motor connected to a driving shaft of the vehicle and having an output port and an input port, the input port of the hydraulic motor connected to the other end of the hydraulic drive pipe;
wherein the hydraulic motor is driven by the hydraulic fluid from the hydraulic cylinder set and drives the driving shaft of the vehicle to rotate; and
the throttle valve regulates an amount of the hydraulic fluid entering the hydraulic motor;
a discharge pipe having two ends, one of the ends of the discharge pipe connected to the output port of the hydraulic motor;
a first branch pipe and a second branch pipe, the first branch pipe and the second branch pipe connected to the other end of the discharge pipe;
a first non-return valve mounted on the first branch pipe; and
a second non-return valve mounted on the second branch pipe;
a solenoid valve set including
a bleed pipe having two ends; and
a main solenoid valve connected to the other end of the re-charge pipe and one of the ends of the bleed pipe;
a first supplementary cylinder set including
a first supplementary cylinder being a hollow tube, filled with the air and the hydraulic fluid, and connected to the first branch pipe;
wherein the first non-return valve on the first branch pipe only allows the hydraulic fluid in the first branch pipe to flow toward the first supplementary cylinder;
a first guiding pipe having two ends respectively connected to a top of the first supplementary cylinder and the main solenoid valve;
a first supplementary pipe having two ends respectively connected to a bottom of the first supplementary cylinder and the hydraulic cylinder;
a first solenoid valve mounted on the first supplementary pipe;
a non-return valve mounted on the first supplementary pipe and in between the first solenoid valve and the hydraulic cylinder, and only allowing the hydraulic fluid in the first supplementary pipe to flow toward the hydraulic cylinder;
a high level switch mounted in the first supplementary cylinder and electrically connected to the main solenoid valve; and
a low level switch mounted in the first supplementary cylinder and below the high level switch of the first supplementary cylinder set, and electrically connected to the first solenoid valve; and
a second supplementary cylinder set including
a second supplementary cylinder being a hollow tube, filled with the air and the hydraulic fluid, and connected to the second branch pipe;
wherein the second non-return valve on the second branch pipe only allows the hydraulic fluid in the second branch pipe to flow toward the second supplementary cylinder;
a second guiding pipe having two ends respectively connected to a top of the second supplementary cylinder and the main solenoid valve;
a second supplementary pipe having two ends respectively connected to a bottom of the second supplementary cylinder and the hydraulic cylinder;
a second solenoid valve mounted on the second supplementary pipe;
a non-return valve mounted on the second supplementary pipe and in between the second solenoid valve and the hydraulic cylinder, and only allowing the hydraulic fluid in the second supplementary pipe to flow toward the hydraulic cylinder;
a high level switch mounted in the second supplementary cylinder and electrically connected to the main solenoid valve; and
a low level switch mounted in the second supplementary cylinder and below the high level switch of the second supplementary cylinder set, and electrically connected to the second solenoid valve.

2. The driving device as claimed in claim 1, wherein the other end of the bleed pipe is connected with a muffler.

3. The driving device as claimed in claim 1, wherein the hydraulic cylinder set further includes a filter mounted on the hydraulic drive pipe and upstream of the throttle valve, and filtering the hydraulic fluid in the hydraulic drive pipe.

4. The driving device as claimed in claim 1, wherein
as the hydraulic fluid in the first supplementary cylinder is increased to a high level position, the main solenoid valve is switched to allow the re-charge pipe to selectively connect with the first guiding pipe or the second guiding pipe; and
as the hydraulic fluid in the second supplementary cylinder is increased to a high level position, the main solenoid valve is switched to allow the re-charge pipe to selectively connect with the first guiding pipe or the second guiding pipe.

5. The driving device as claimed in claim 2, wherein
as the hydraulic fluid in the first supplementary cylinder is increased to a high level position, the main solenoid valve is switched to allow the re-charge pipe to selectively connect with the first guiding pipe or the second guiding pipe; and
as the hydraulic fluid in the second supplementary cylinder is increased to a high level position, the main solenoid valve is switched to allow the re-charge pipe to selectively connect with the first guiding pipe or the second guiding pipe.

6. The driving device as claimed in claim 3, wherein
as the hydraulic fluid in the first supplementary cylinder is increased to a high level position, the main solenoid valve is switched to allow the re-charge pipe to selectively connect with the first guiding pipe or the second guiding pipe; and
as the hydraulic fluid in the second supplementary cylinder is increased to a high level position, the main solenoid valve is switched to allow the re-charge pipe to selectively connect with the first guiding pipe or the second guiding pipe.

7. The driving device as claimed in claim 1, wherein
when the hydraulic fluid in the first supplementary cylinder is reduced to a low level position, the low level switch of the first supplementary cylinder set is switched to block the first supplementary pipe; and
when the hydraulic fluid in the second supplementary cylinder is reduced to a low level position, the low level switch of the second supplementary cylinder set is switched to block the second supplementary pipe.

8. The driving device as claimed in claim 2, wherein
when the hydraulic fluid in the first supplementary cylinder is reduced to a low level position, the low level switch of the first supplementary cylinder set is switched to block the first supplementary pipe; and
when the hydraulic fluid in the second supplementary cylinder is reduced to a low level position, the low level switch of the second supplementary cylinder set is switched to block the second supplementary pipe.

9. The driving device as claimed in claim 3, wherein
when the hydraulic fluid in the first supplementary cylinder is reduced to a low level position, the low level switch of the first supplementary cylinder set is switched to block the first supplementary pipe; and
when the hydraulic fluid in the second supplementary cylinder is reduced to a low level position, the low level switch of the second supplementary cylinder set is switched to block the second supplementary pipe.

10. The driving device as claimed in claim 4, wherein
when the hydraulic fluid in the first supplementary cylinder is reduced to a low level position, the low level switch of the first supplementary cylinder set is switched to block the first supplementary pipe; and
when the hydraulic fluid in the second supplementary cylinder is reduced to a low level position, the low level switch of the second supplementary cylinder set is switched to block the second supplementary pipe.

11. The driving device as claimed in claim 5, wherein
when the hydraulic fluid in the first supplementary cylinder is reduced to a low level position, the low level switch of the first supplementary cylinder set is switched to block the first supplementary pipe; and
when the hydraulic fluid in the second supplementary cylinder is reduced to a low level position, the low level switch of the second supplementary cylinder set is switched to block the second supplementary pipe.

12. The driving device as claimed in claim 6, wherein
when the hydraulic fluid in the first supplementary cylinder is reduced to a low level position, the low level switch of the first supplementary cylinder set is switched to block the first supplementary pipe; and
when the hydraulic fluid in the second supplementary cylinder is reduced to a low level position, the low level switch of the second supplementary cylinder set is switched to block the second supplementary pipe.
